(19) United States
(12) Patent Application Publication
(10) Pub. No.: US 2012/0294320 A1
(43) Pub. Date: Nov. 22, 2012

(54) TUNABLE LASER SYSTEM AND METHOD

(75) Inventors: Brian Corbett, Cork (IE); Brendan Roycroft, Cork (IE); Liam Barry, Dublin (IE); Frank Smyth, Dublin (IE); Kai Shi, Dublin (IE)

(73) Assignee: UNIVERSITY COLLEGE CORK, NATIONAL UNIVERSITY OF IRELAND, Cork (IE)

(21) Appl. No.: 13/438,685

(22) Filed: Apr. 3, 2012

Related U.S. Application Data
(63) Continuation-in-part of application No. 13/422,570, filed on Mar. 16, 2012.
(60) Provisional application No. 61/454,237, filed on Mar. 18, 2011.

(51) Int. Cl. H01S 3/10

(52) U.S. Cl. 372/20

(57) ABSTRACT

According to the invention there is provided a tunable laser system for use in an optical communication system, said tunable laser system comprising a multi-section laser separated by at least two slots to define a plurality of sections, each section adapted to provide an optical gain. Each section comprises a separate control means to provide an adjustable optical gain in each section. The tunable laser system and method of the present invention provides a wide tuning range, narrow linewidth and fast switching times.

### CROSS REFERENCE TO RELATED APPLICATIONS

This application is a continuation-in-part of U.S. patent application Ser. No. 13/422,570, filed Mar. 16, 2012, which claims the benefit of U.S. Provisional Patent Application No. 61/454,237, filed Mar. 18, 2011, which are incorporated by reference as if fully set forth herein.

### FIELD OF INVENTION

The invention relates to a tunable laser. In particular the invention relates to a tunable laser system and method that provides a wide tuning range, narrow linewidth and fast switching times.

### BACKGROUND

Widely tunable lasers have become a mainstream component in optical networks because they allow a reduction in inventory management, and offer simple solution to the need for sparing resources. More recently they have emerged as a key component in reconfigurable optical transport systems by offering dynamic wavelength selectivity. The most common widely used tunable laser is the Sampled Grating Distributed Bragg Reflector (SG-DBR) laser which offers quasi-continuous tuning over wide tuning range and side mode suppression ratio (SMSR) of over 40 dB.

In addition these lasers can switch on nanosecond timescales, which makes them suitable for optical packet switching. A problem associated with the SG-DBR laser is the complex fabrication process and low yield. The primarily employed modulation format in current optical transmission systems is on-off keying (OOK). However advanced optical modulation formats, such as phase-shift-keying (PSK), have seen much interest in recent years due to their lower requirement on optical signal-to-noise ratio (OSNR), higher spectral efficiency and higher tolerance to fiber nonlinear effects. The linewidth of the laser, which is related to the phase noise, is therefore increasing in importance.

A type of tunable laser structure known as a tunable slotted Fabry Perot (SFP) laser that offers wide (discrete) tunability, high SMSR and sub nanosecond switching is disclosed in a paper by F. Smyth, E. Connolly, B. Roycroft, B. Corbett, P. Lambkin and L. P. Barry, “Fast wavelength switching lasers using two-section slotted Fabry-Perot structures,” IEEE PTL 18, 2105-2107 (2006). These lasers have a single growth fabrication process and only use standard lithography, which significantly reduces the cost and complexity of fabrication while increasing the yield. Self-coherent phase modulation formats such as differential phase shift keying (DPSK) use differential direct detection that does not need an optical local oscillator as is required in fully coherent receivers. DPSK has been used in long-haul point to point transmission systems, as well as for an orthogonally modulated label in wavelength routing packet switching systems. A problem with this type of laser is that it is difficult to control the optical gain that is required for commercial applications.

Recently self-coherent transmission has also gained interest in wavelength reuse based WDM-PON, F. Ponzini, et al., “Evolution scenario toward WDM-PON,” J. Opt. Commun. Netw. 1, 25-34 (2009). A narrow linewidth tunable laser not only removes the need for digital signal processing (DSP) based phase reconstruction for short distance access networks, but also enables DPSK at lower baud rates and/or higher order modulation formats.

The requirements on tunable lasers for use in telecommunications are evolving. In addition to accessing wavelengths across the c-band there is a need for extended tuning, for tuning on a fixed grid (e.g., 400, 200, 100, 50, 25 GHz), for tuning on a nanosecond time scale, for having a narrow optical linewidth to enable use with advanced modulation formats and for the generation of coherent combs of wavelengths. The main problem is that this is difficult to achieve a controllable tunable laser with these characteristics.

There is therefore a need to provide a tunable laser system and method to overcome the above mentioned problems.

### SUMMARY

According to the invention there is provided a tunable laser system for use in an optical communication system, said tunable laser system comprising:

a multi-section laser separated by at least two slots to define a plurality of sections, each section adapted to provide an optical gain; and each section comprises a separate control means to provide an adjustable optical gain in each section.

The tunable laser system and method of the present invention provides a wide tuning range and fast switching times. In addition to its wide tuning range and fast switching speed, the linewidth of the laser has been found to be less than 800 kHz for the 25 available channels on the 100 GHz ITU grid. This is over five times narrower than the optimum linewidth of a commercial SG-DBR tunable laser. The tunable laser system provides a low linewidth, low cost tunable laser such as the SFP laser can be used to improve the performance of wavelength tunable self-coherent transmission systems, and provides an ideal transmitter for use in optical access networks that employ advanced modulation formats.

The laser system of the present invention can be used to generate a coherent comb of wavelengths (>5) separated by an electronically controlled frequency spacing (eg 10, 25, 50 GHz) under gain switching. These optical combs can be used as parallel channels on a WDM link requiring only a single wavelength locking element. Thus using the tuning property of the laser, the same laser design can be used to generate combs on a selected frequency separation (e.g., 100, 400, 800 GHz). An array of lasers can cover the C band.

In one embodiment the separate control means comprises a differential current source for at least one section.

In one embodiment the differential current source comprises means for injecting current into a section to adjust the optical gain.

In one embodiment the control means comprises a voltage control source for at least one section. Suitably the voltage applied to one section is less that the bandgap voltage.

In one embodiment the slots are dimensioned at a depth to allow for modulation of the wavelength spectrum of the laser. Suitably the depth of the slot is set by an etch stop layer in the laser structure.

In one embodiment the slots comprises partially reflective material.

In one embodiment the slots comprise of intermixed material.

In one embodiment at least one section comprises intermixed material.

In one embodiment at least one section comprises material with a different bandgap.

In one embodiment the slots are selected in the multi-section laser to define a grid of wavelengths separated by a desired channel spacing.

In one embodiment the multi-section laser is adapted such that the optical gain is peaked within the channel spacing so that only one mode can lase.

In one embodiment the system comprises a calibration means with known gain spectrum and resonant modes to program the multi-section laser to operate at any known temperature.

In one embodiment the multi-section laser comprises a Slotted Fabry-Perot Device.

In one embodiment said laser comprises three sections.

A transmitter for use in an optical network comprising a tunable laser system having a multi-section laser separated by at least two slots to define a plurality of sections, each section adapted to provide an optical gain; and each section comprises a separate control means to provide an adjustable optical gain in each section.

In another embodiment there is provided a tunable laser system for use in an optical communication system, said tunable laser system comprising:

a multi-section laser configured with at least two slots to define a plurality of sections; at least one first section comprising a separate control means to provide an adjustable optical gain in the first section; and at least one second section comprising an intermixed section and a separate control means adapted to shift a bandgap in said second section.

There is also provided a computer program comprising program instructions for causing a computer program to carry out the above method which may be embodied on a record medium, carrier signal or read-only memory.

### BRIEF DESCRIPTION OF THE DRAWINGS

The invention will be more clearly understood from the following description of an embodiment thereof, given by way of example only, with reference to the accompanying drawings, in which:

FIG. 1 illustrates a three section tunable laser;

FIG. 2 illustrates tuning range delivered by a three section laser;

FIG. 3 illustrates a Slotted Fabry-Perot system with a control means according to a preferred embodiment of the invention;

FIG. 4 Measured line shape of SG-DBR laser with a linewidth of 4.2 MHz (⋄), 19.8 MHz (□) and SFP laser with a linewidth of 738 kHz (∘);

FIG. 5 illustrates an experimental set up to compare the performance of the SFP laser system with the control means according to the invention and a known SG_DBR laser;

FIG. 6 illustrates BER of 1.2 5G/s DPSK transmission using (a) SFP laser at 4 ITU channels back to back, (b) SG-DBR laser at 194.2 THz channel with 4.2 MHz and 19.8 MHz linewidth. The BER of 1.25 G/s DPSK transmission using SFP laser at 194.2 THz without () and with (∘) 24 km of fiber is also shown; and

FIG. 7 illustrates the shift of the gain spectra (peak wavelength and modal gain as a function of injected current) and the resonant modes (peak wavelengths) with temperature.

### DETAILED DESCRIPTION OF THE PREFERRED EMBODIMENTS

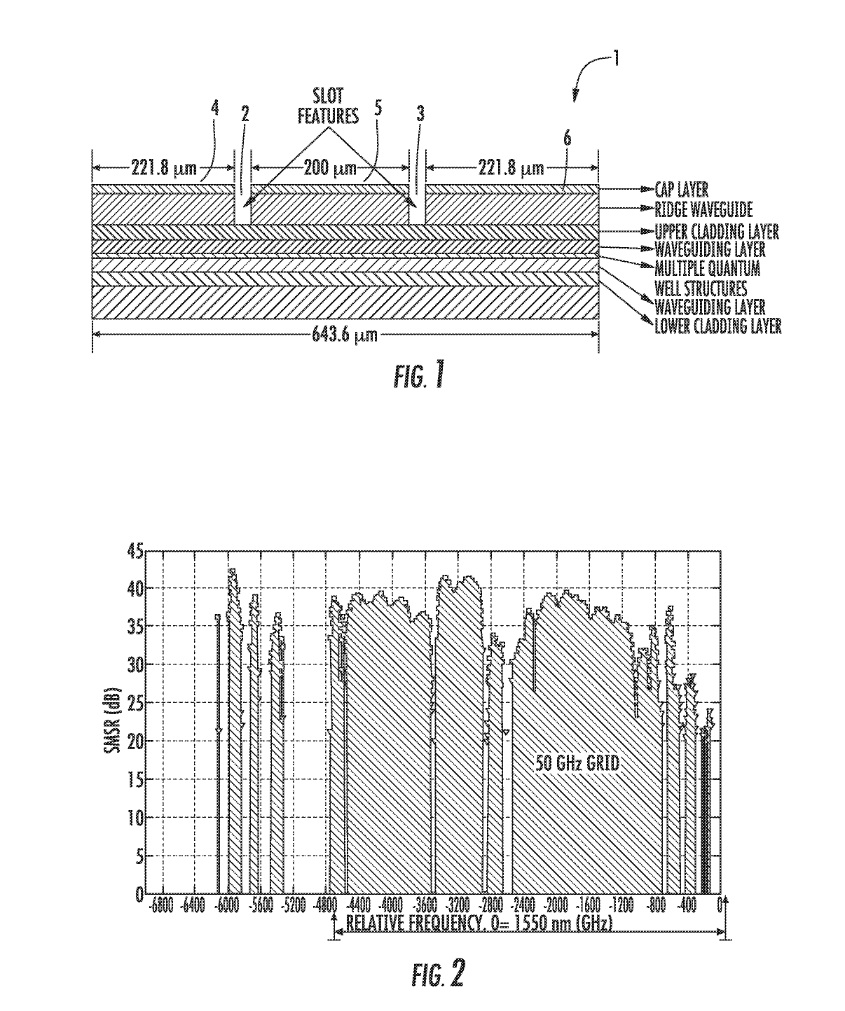

Referring now to the drawings and initially FIG. 1, there is illustrated a three section tunable laser indicated generally by the reference numeral 1 separated by at least two slots 2 and 3. The at least two slots 2, 3 define a plurality of sections, 4, 5 and 6 to define a three section SFP laser wherein each section 4,5 and 6 is adapted to provide an optical gain. Alternatively the tuning mechanism for the three section SFP laser can be the injection of optical power into the other two sections and subsequently reduce the clamped carrier density. The laser 1 is designed to provide sufficient modulation depth in the spectrum while remaining reasonably simple to drive. Key fabrication points relate to the depth of the slot to have preferably ˜19% of the mode energy interacting with the slot. This does not increase the laser threshold significantly while providing reproducible results. An etch stop layer can be easily incorporated in the laser structure to guarantee the correct etch depth. The length of the laser cavity and the distances to the slots is also of importance. A self-aligned cleaving groove can assist with this.

A fibre coupled laser device of the invention, described in more detail below with respect to FIG. 3, can provide a wide tuning range (25 channels on a 100 GHz grid), narrow linewidth (average linewidth of 500 kHz and maximum of 800 kHz), fast switching (<5 ns for a 4×4 array of channels), and 10 ns to switch wavelengths and to be successfully be sending data with bit error ratio of <10⁹ and the use of the laser in sending DQPSK data. The invention can be characterised such devices obtaining 81 consecutive channels with SMSR>20 dB on 50 GHz grid (4.0 THz coverage), quasi-continuous for nearly 2 THz for tuning current in 2 mA steps up to 60 mA in each of the three sections as shown in FIG. 2).

Referring to FIG. 3, FIG. 3 illustrates a tunable laser system for use in an optical communication system according to a preferred embodiment of the invention indicated generally by the reference numeral 10. The tunable laser system 10 comprises a multi-section laser separated by at least two slots 11, 12 to define a plurality of sections 13, 14 and 15, each section adapted to provide an optical gain. The slot region 11, 12 supports a waveguided mode and the overlap of the mode between the waveguide and the slot or interrupted region is between 50% and 95%. Each section, 13, 14 or 15 comprises a separate control means 16, 17 18 to provide an adjustable optical gain in each section. The separate control means 16, 17, 18 is provided in the form of a separate variable DC current source that is adapted to inject current into each section to control the optical gain.

The tunable laser used in the present invention is preferably a Slotted Fabry-Perot (SFP) device. The SFP device of the present invention consists of a ridge waveguide semiconductor laser, separated into three active sections by two single slots etched into the waveguide. By varying the drive current to each section individually, the gain and index of each section of the laser is controlled such that single mode lasing is achieved in any of 25 100 GHz spaced ITU channels.

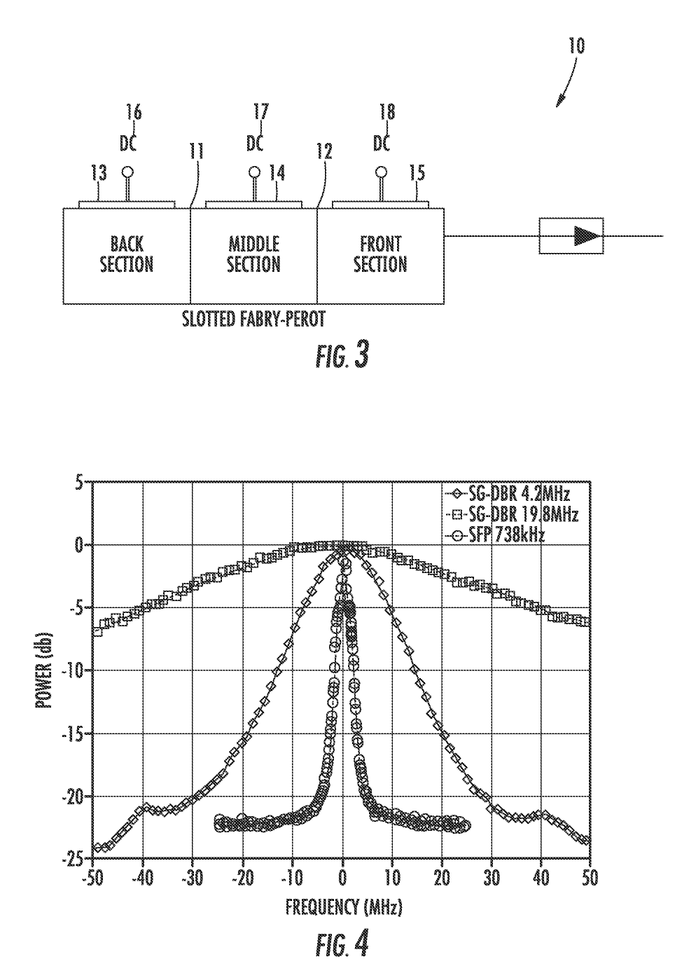

In order to compare the linewidth with other laser devices the linewidth of the SFP laser (FIG. 3) and a known SG-DBR laser was characterized using the delayed self-heterodyne method, for example as disclosed in D. Derickson, Fiber Optics: Test and Measurement (Prentice Hall, N.J., 1998), Chapter. 5. Identical DC current sources (Thorlabs ITC-502) were used for both lasers. The measured lineshape of both the SFP laser and the SG-DBR laser are shown in FIG. 4. With both lasers, the individual channels can be obtained via different drive current combinations and this resulted in varying linewidths, however this linewidth variation was much more pronounced for the SG-DBR laser. The worst measured linewidth of the SFP laser is approximately 738 kHz at channel 194.2 THz. For the SG-DBR, two sets of operating currents were chosen to give emission of the 194.2 THz channel. Both exhibited SMSR greater than 45 dB but the linewidths varied (as shown in FIG. 4) from 4.2 MHz to 19.8 MHz. Thus, the widest linewidth from the tunable SFP laser of the present invention is over five times narrower than the narrowest linewidth SG-DBR channel. This is a major performance jump in linewidth over laser prior art systems.

FIG. 5 illustrates an experimental set up to compare the performance of the three section SFP laser system 10 with the separate control means for each section according to the invention and a known SG-DBR laser 20. The SG-DBR laser 20 used was a commercial device obtained from JDSU Corporation while the tunable SFP was fabricated within the Tyndall National Institute, University College Cork, Ireland. Both lasers were butterfly packaged and optically isolated. A Mach Zehnder modulator 30(MZM), which was biased at the null point, followed the laser transmitter, and this was used to generate the optical DPSK signal. The modulator was driven by a 2³¹-1 bits pseudorandom bit sequence (PRBS) signal at 1.25 Gb/s from a pulse pattern generator (PPG). The power falling onto the receiver was monitored and adjusted using the first variable optical attenuator (VOA). The receiver consisted of a pre-amp erbium doped fiber amplifier (EDFA) and a power amp EDFA, each followed by a 2 nm Optical Band Pass Filter (OBPF) to reduce the out of band amplified spontaneous emission (ASE) noise. A Michelson Delay Interferometer 40 (MDI) was used as a demodulator for the 1.25 Gb/s DPSK signal. The delay between the two paths of the interferometer was set to equal the duration of one bit slot, which is 800 ps. A second VOA was used to ensure that the power falling on the photoreceiver remained constant, and the photoreceiver was connected to the error detector and oscilloscope that were used to examine the system performance.

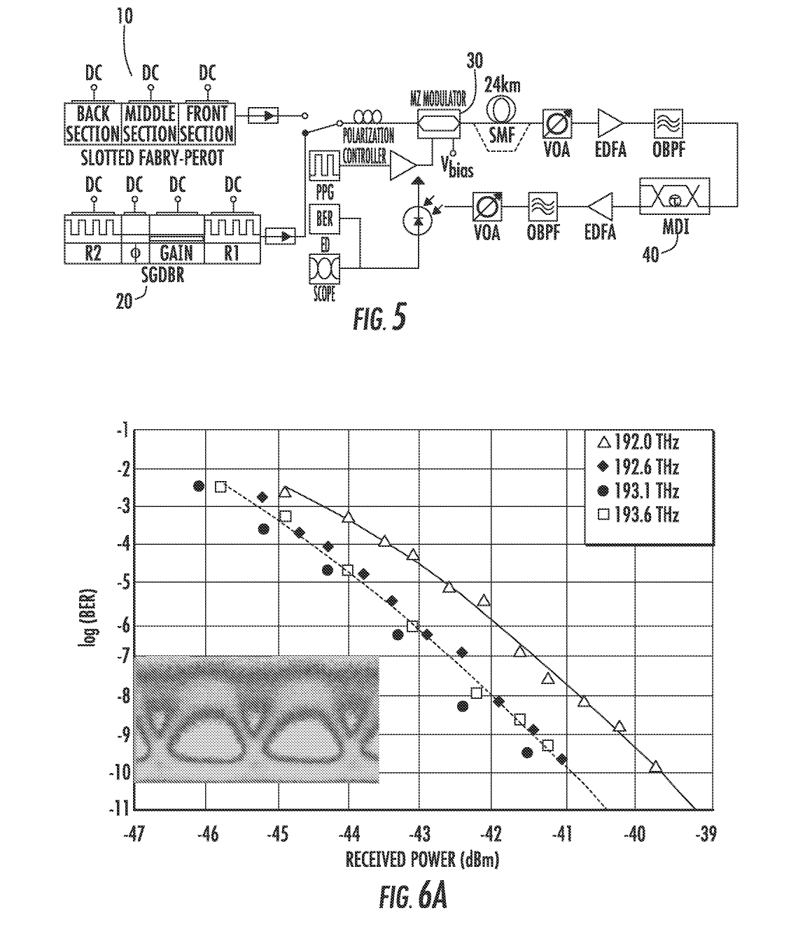

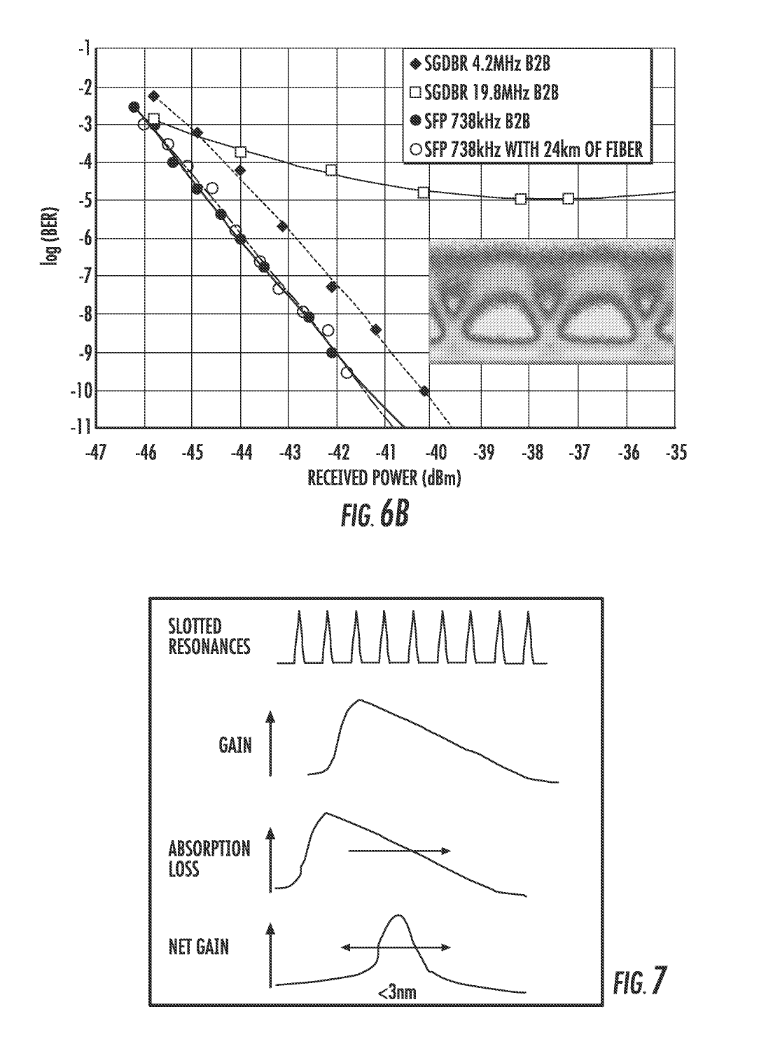

The corresponding demodulated bit error rate (BER), obtained from the error detector, is displayed in FIG. 6. It is important to note that by using a balanced detector, a 3 dB improvement in sensitivity can be obtained. Five channels of the SFP laser were chosen for the experiment with frequencies between 192.0 THz and 194.2 THz with approximately 0.5 THz spacing. Error free performance was achieved with the SFP laser at five different channels (see FIG. 6(a) and (b)) spread across the operating wavelengths of the SFP laser. The 192.0 THz channel suffers a performance penalty due to the reduction in EDFA gain at its position towards the edge of the EDFA operating region. The 194.2 THz channel of the SFP laser and the 194.2 THz channel of the SGDBR laser were chosen for comparison. As shown in FIG. 6(b), a 1 dB penalty at a BER of 1□10⁻⁹ can be found between a 4.2 MHz linewidth of the SGDBR laser and a 738 kHz linewidth of the SFP laser. An error floor at 1□10⁻⁵ is observed when the linewidth of the SGDBR laser is 19.8 MHz. The received eyes at −41.8 dBm of the SFP laser and the SG-DBR laser with 19.8 MHz linewidth are shown as the insets in FIG. 3. The phase noise can be found as the random dots spreading across the eye opening in the insets of FIG. 6. FIG. 3(b) also shows the performance of the SFP laser being transmitted through 24 km of standard single mode fiber (SSMF). As expected, the penalty between the curves without fiber and with 24 km of fiber is negligible because at such low data rates the dispersion effect of the fiber is small.

The error floor exhibited by the SG-DBR with binary DPSK indicates that its linewidth would not support higher order modulation formats such as DQPSK and 8-QAM at 1.25 Gbaud, which could be used to obtain higher aggregate data rates using low speed electronics. Other varieties of low linewidth tunable lasers such as external cavity lasers (ECLs) would support these higher order modulation formats, but they are expensive, and are too slow for fast switching applications. It is appreciated that the tunable SFP laser with its low linewidth will support these formats and this, coupled with its low fabrication cost and fast switching speed makes it extremely suitable for future wavelength switched systems such as WDM-PON.

In order for the tunable laser of the present invention to operate it is necessary to obtain well controlled ‘mode maps’, to identify the fast switching channels, to have a fine wavelength control and to integrate with an amplifier chip to flatten the output power. A rapid characterisation method is also needed. It is highly desirable that the modemap (i.e., the change in lasing wavelength with changes in temperature) is monotonic. This is generally not the case for the lasers discussed above or for other tunable lasers. Generally the mode map of these devices has to be individually characterised and this map will be temperature sensitive resulting in a large cost in testing each device. Exceptions are MEMS based VCSELs and external cavity lasers which have their own problems (power, complexity, reliability). An additional arrangement of the multi-section laser of the invention is to design a sequence of partially reflective slots in an active waveguide structure to define a grid of favoured wavelengths separated by the desired channel spacing such as by 3 nm or by 5 nm according to the design. The second aspect is to engineer a gain spectrum for the laser which is peaked within the channel spacing so that only one mode can lase. The gain spectrum is to be adjusted by current/voltage control. The overall mode gain is the sum of the modal gain/loss of the two sections. Again the mode selection can be carried by the gain spectrum or the Vernier effect, introduced by the different mode spacing of different sections.

The shift of the gain spectra (peak wavelength and modal gain as a function of injected current) and the resonant modes (peak wavelengths) with temperature will be calibrated. These will shift monotonically with temperature and current and will be characteristic for the wafer design and the slot arrangement. This known calibration can then be used to program the device to enable the device to operate at any known temperature, as shown in FIG. 7. The calibration is expected to be common for all devices on a wafer and so can lead to a low cost. A third control may be required to assist with the device modulation for generation of data or for generation of an optical comb as the application may require. Improved control of the tuning map can be achieved by inter-mixing the active region in selected areas of the device. This results in a change in the band edge of the quantum well material in that section of the device. Typically the differential shift to shorter wavelength to be beneficially used will be in the range of 20-50 nm. The dielectric response function describing the gain, refractive index and absorption of this section is now changed with respect to the other regions in the device and the tuning control can be obtained by biasing the section in strong absorption (negative voltage applied), weak absorption (voltage less than the bandgap voltage), in transparency (bandgap voltage) or spectrally shifted gain (voltage greater than the bandgap). Monitoring of the current on the individual sections provides an additional control. The shift in bandgap can be achieved during the growth process resulting in a material with a different bandgap at different locations.

It will be appreciated that the present invention provides a three section tunable laser with narrow linewidth has been employed in a 1.25 Gb/s DPSK transmission system. This type of laser has a single growth fabrication process and only uses standard lithography, which reduces the cost while increasing the yield. In addition to its wide tuning range and fast switching speed, the linewidth of the laser has been found to be less than 800 kHz for the 25 available channels on the 100 GHz ITU grid. This is over five times narrower than the optimum linewidth of a commercial SG-DBR tunable laser. Error free transmission has been achieved for five different channels of the laser and similar performance is expected for all channels due to their similar low linewidth. As such, these lasers can be used as suitable transmitters for wavelength switched systems employing higher order modulation formats.

The laser is usually operated with three independent current or voltage supplies to obtain full tuning characteristics. However, it is common to drive two sections from one supply, while varying the third section, or to connect all three sections together for ease of driver control. This results in a more limited tuning behaviour, but is often sufficient for a particular application, for example high speed switching between two channels. Bias currents/voltages can be positive or negative, as the laser can operate when one of the sections is under reverse bias. When one of the sections has low or negative bias, it acts as a wavelength dependent absorber within the cavity. This can be useful to shift the lasing wavelength to longer wavelength, as shorter wavelengths are absorbed preferentially.

If one or two sections are held under constant bias while the third bias is changed, a jump in wavelength as the laser switches channels can be determined by monitoring the voltage/current in the constant section(s). Usually a change in wavelength needs to be measured on an instrument such as an Optical Spectrum Analyser or Wavemeter, but in this case the change can be determined by a change in voltage/current in a section which is under constant bias. This is due to the change in carrier recombination rate in the section as the laser comes to a different equilibrium at different operating wavelengths. This is particularly noticeable when one of the sections is at low/negative bias, but is not limited to such conditions. Electrical isolation between the sections provided by the slot is important here, so the slot is useful in practice for both optical and electrical properties.

Low or negative bias in one section can also be useful in laser characterisation as this can be used to separate the contributions of each section of the laser in the overall operation of the laser. As a reverse biased section in general does not contribute to the overall lasing action, the properties of those sections which do contribute can be more easily determined. For example, the change of optical phase within one section as a function of bias above threshold can be determined.

One section may also be made substantially transparent, for example by quantum well intermixing or by the growth of a material of a different wavelength, and tuning laser operation will still be obtained. In this case a bias on the transparent section can give a refractive index change within the laser cavity, thus acting as another means of tuning the wavelength.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

The invention is not limited to the embodiments hereinbefore described but may be varied in both construction and detail.

What is claimed is:

1. A tunable laser system for use in an optical communication system, said tunable laser system comprising:
a multi-section laser configured with at least two slots to define a plurality of sections, each section adapted to provide an optical gain; and
each section comprises a separate control mechanism to provide an adjustable optical gain in each section.

2. The tunable laser system of claim 1, wherein the separate control mechanism comprises a differential current source for each section.

3. The tunable laser system of claim 1, wherein the separate control mechanism comprises a differential current source for each section, at least one source is adapted for injecting current into a section to adjust the optical gain.

4. The tunable laser system according to claim 1, wherein the slots are dimensioned at a depth to allow for modulation of the wavelength spectrum of the laser.

5. The tunable laser system as claimed in claim 1, wherein the slots are dimensioned at a depth to allow for modulation of the wavelength spectrum of the laser and the depth of the slot is set by an etch stop layer in the laser structure.

6. The tunable laser system according to claim 1, wherein the slots comprises partially reflective material.

7. The tunable laser system according to claim 1, wherein the slots are selected in the multi-section laser to define a grid of wavelengths separated by a desired channel spacing.

8. The tunable laser system according to claim 7, wherein the slots are selected in the multi-section laser to define a grid of wavelengths separated by a desired channel spacing and the multi-section laser is adapted such that the optical gain is peaked within the channel spacing so that only one mode can lase.

9. The tunable laser system according to claim 1, comprising a calibration system with known gain spectrum and resonant modes to program the multi-section laser to operate at any known temperature.

10. The tunable laser system according to claim 1, wherein a voltage less than a bandgap voltage is applied to one section.

11. The tunable laser system according to claim 1 wherein said laser comprises three sections where at least two sections have lengths within 1% of each other.

12. A tunable laser system for use in an optical communication system, said tunable laser system comprising:
a multi-section laser configured with at least two slots to define a plurality of sections;
at least one first section comprising a separate control mechanism to provide an adjustable optical gain in the first section; and
at least one second section comprising an intermixed section and a separate control mechanism adapted to shift a bandgap in said second section.

13. The tunable laser system according to claim 12, wherein a voltage less than a bandgap voltage is applied to one section of the laser.

14. A transmitter for use in an optical network comprising:
a tunable laser system having a multi-section laser separated by at least two slots to define a plurality of sections, each section adapted to provide an optical gain; and
each section comprises a separate control mechanism to provide an adjustable optical gain in each section.
